(19) United States
(12) Patent Application Publication
(10) Pub. No.: US 2025/0215834 A1
(43) Pub. Date: Jul. 3, 2025

(54) GAS TURBINE CONTROL DEVICE, GAS TURBINE CONTROL METHOD, AND GAS TURBINE CONTROL PROGRAM

(71) Applicant: MITSUBISHI HEAVY INDUSTRIES, LTD., Tokyo (JP)

(72) Inventors: Kuniharu FUJIBAYASHI, Tokyo (JP); Teruhiro MATSUMOTO, Tokyo (JP)

(21) Appl. No.: 18/851,434

(22) PCT Filed: Apr. 11, 2023
(86) PCT No.: PCT/JP2023/014648

§ 371 Date: Sep. 26, 2024

(30) Foreign Application Priority Data
Apr. 20, 2022 (JP) 2022-069362

(51) Int. Cl. F02C 9/26; F02C 7/22; F23R 3/28

(52) U.S. Cl. CPC F02C 9/26; F02C 7/22; F23R 3/28

(57) ABSTRACT

A gas turbine control device controls a gas turbine in which a combustor is configured in a state where fuel supply nozzles are separated into a first group and a second group. This device calculates a control parameter base index relating to the ratio of the amount of fuel supplied by the second group to the amount of fuel supplied by the first group. The base index is corrected using a correction value calculated based on the operating state of the gas turbine. The amounts of fuel supplied by the first group and the second group are controlled based on a control parameter obtained by correcting the base index using the correction value. This correction value is calculated so that the absolute value thereof decreases to zero after the gas turbine has been started up and a prescribed length of time has passed since load addition to the gas turbine.

### TECHNICAL FIELD

The present disclosure relates to a gas turbine control device, a gas turbine control method, and a gas turbine control program.

The present application claims priority based on Japanese Patent Application No. 2022-069362 filed in Japan on Apr. 20, 2022, the contents of which are incorporated herein by reference.

### BACKGROUND ART

A gas turbine including a compressor and a combustor is known. In the gas turbine, air taken in from an air intake port is compressed by the compressor to generate compressed air, and in the combustor, fuel is supplied to the compressed air to be combusted, thereby generating a high-temperature and high-pressure combustion gas. The gas turbine has a turbine configured to have a plurality of turbine stator vanes and a plurality of turbine rotor blades alternately disposed in a passage in a casing, and the turbine rotor blade is driven by a combustion gas generated by the combustor, so that a rotor connected to, for example, a generator is rotationally driven. The combustion gas that drives the turbine is converted into a static pressure by a diffuser and then discharged to an outside.

This type of gas turbine is designed on the premise that a temperature of the fuel supplied to the combustor is in a predetermined range. For example, in a case where the fuel temperature is within the predetermined range, exhaust gas from the gas turbine is controlled to satisfy a predetermined reference by applying an exhaust gas compliance combustion mode to the gas turbine. However, in a case where the fuel temperature is outside the predetermined range, the exhaust gas compliance combustion mode is not applied, and an initial activation mode corresponding to the low-temperature fuel is applied. In contrast, PTL 1 discloses a control method for a gas turbine for applying the exhaust gas compliance combustion mode even when the fuel temperature is outside the predetermined range.

### CITATION LIST

### Patent Literature

[PTL 1] Japanese Patent No. 5336346

### SUMMARY OF INVENTION

### Technical Problem

In a case where a load is increased by adding (inputting) the load at a time of activating the gas turbine, combustion oscillation may occur in the gas turbine. Therefore, in the fuel supply control for the combustor of the gas turbine in the related art, the control of a combustion parameter is performed to ensure a tolerance for combustion oscillation. However, the tolerance for the combustion depth decreases as the fuel temperature decreases, and combustion oscillation is likely to occur. In the related art, since the activation time of the gas turbine was sufficiently long, the risk of occurrence of combustion oscillation was low due to a certain degree of increase in fuel temperature when the load was added. However, in recent years, a gas turbine capable of rapid activation has been required in accordance with an increase in power generation amount by renewable energy in a power system. In a case of a rapid activation, it is also assumed that the load is added before the fuel temperature sufficiently rises, the risk of occurrence of combustion oscillation increases, and in some cases, there is a possibility that the gas turbine will trip.

At least one embodiment of the present disclosure has been made in view of the above circumstances, and an object of the present disclosure is to provide a gas turbine control device, a gas turbine control method, and a gas turbine control program capable of suppressing the occurrence of combustion oscillation even in a case where a load is added in a state where a fuel temperature is low at the time of activation.

### Solution to Problem

In order to solve the above problem, according to at least one embodiment of the present disclosure, there is provided a gas turbine control device for controlling a gas turbine in which a combustor is configured in a form in which a plurality of fuel supply nozzles for supplying fuel are divided into a first group and a second group, the gas turbine control device including a base index calculation unit for calculating a base index of a control parameter regarding a ratio of a fuel supply amount by the second group to a fuel supply amount by the first group, based on an operating state of the gas turbine, a correction value calculation unit for calculating a correction value for correcting the base index, based on the operating state of the gas turbine, and a fuel control unit for controlling each of the fuel supply amounts by the first group and the second group, based on the control parameter obtained by correcting the base index using the correction value, in which the correction value calculation unit calculates the correction value such that an absolute value of the correction value decreases to zero, when a predetermined period elapses from a time when a load is added to the gas turbine after the gas turbine is activated.

In order to solve the above problem, according to at least one embodiment of the present disclosure, there is provided a gas turbine control method for controlling a gas turbine in which a combustor is configured in a form in which a plurality of fuel supply nozzles for supplying fuel are divided into a first group and a second group, the gas turbine control method including a step of calculating a base index of a control parameter regarding a ratio of a fuel supply amount by the second group to a fuel supply amount by the first group, based on an operating state of the gas turbine, a step of calculating a correction value for correcting the base index, based on the operating state of the gas turbine, and a step of controlling each of the fuel supply amounts by the first group and the second group, based on the control parameter obtained by correcting the base index using the correction value, in which, in the step of calculating the correction value, the correction value is calculated such that an absolute value of the correction value decreases to zero, when a predetermined period elapses from a time when a load is added to the gas turbine after the gas turbine is activated.

In order to solve the above problem, according to at least one embodiment of the present disclosure, there is provided a gas turbine control program for controlling a gas turbine in which a combustor is configured in a form in which a plurality of fuel supply nozzles for supplying fuel are divided into a first group and a second group, the gas turbine control program capable of being executed by using a computer, the gas turbine control program including a step of calculating a base index of a control parameter regarding a ratio of a fuel supply amount by the second group to a fuel supply amount by the first group, based on an operating state of the gas turbine, a step of calculating a correction value for correcting the base index, based on the operating state of the gas turbine, and a step of controlling each of the fuel supply amounts by the first group and the second group, based on the control parameter obtained by correcting the base index using the correction value, in which, in the step of calculating the correction value, the correction value is calculated such that the correction value decreases to zero, when a predetermined period elapses from a time when a load is added to the gas turbine after the gas turbine is activated.

### Advantageous Effects of Invention

According to at least one embodiment of the present disclosure, a gas turbine control device, a gas turbine control method, and a gas turbine control program capable of suppressing the occurrence of combustion oscillation even in a case where a load is added in a state where a fuel temperature is low at the time of activation can be provided.

### BRIEF DESCRIPTION OF DRAWINGS

FIG. 1 is a schematic configuration diagram of a gas turbine according to an embodiment.

FIG. 2 is a schematic configuration diagram of a combustor in the gas turbine of FIG. 1.

FIG. 3 is a schematic cross-sectional view of FIG. 2.

FIG. 4 is a block configuration diagram showing a gas turbine control device according to the embodiment.

FIG. 5 is a processing flowchart of a fuel control unit of FIG. 4 in an oscillation suppression mode.

FIG. 6 is an example of a first function in a case where KMB is treated as a control parameter.

FIG. 7 is an example of a second function in a case where the KMB is treated as the control parameter.

FIG. 8 is an example of a third function in a case where the KMB is treated as the control parameter.

FIG. 9 is an example of a first function in a case where a top hat ratio is treated as the control parameter.

FIG. 10 is an example of a second function in a case where the top hat ratio is treated as the control parameter.

FIG. 11 is an example of a third function in a case where the top hat ratio is treated as the control parameter.

FIG. 12 is a processing flowchart of a gain correction unit of FIG. 5.

FIG. 13 is a diagram showing a fourth function of FIG. 5.

FIG. 14 is a diagram showing a fifth function of FIG. 5.

FIG. 15 is a diagram showing a sixth function of FIG. 5.

FIG. 16 is a flowchart showing a gas turbine activation method according to the embodiment.

FIG. 17 is a time chart showing a change over time of various indices related to an operating state of the gas turbine at a time of activation.

### DESCRIPTION OF EMBODIMENTS

Hereinafter, some embodiments of the present invention will be described with reference to the accompanying drawings. Meanwhile, configurations described in the embodiments or shown in the drawings are not intended to limit the scope of the present invention, and are merely examples for description.

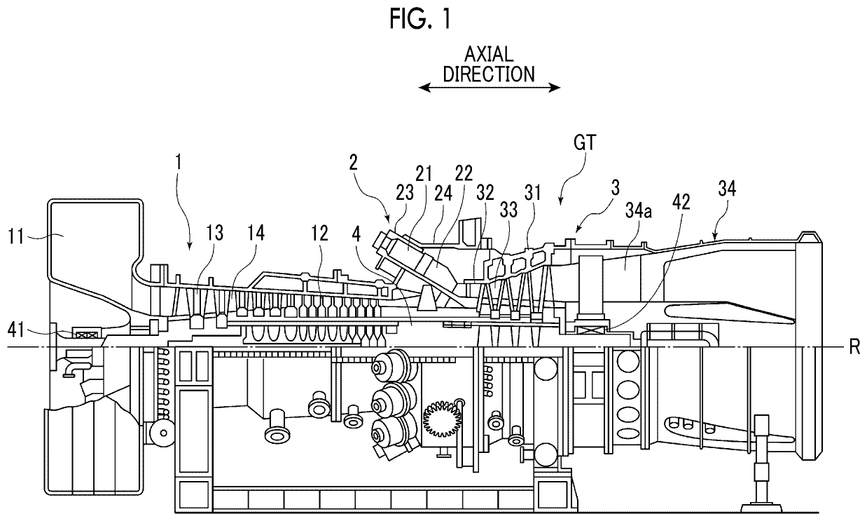

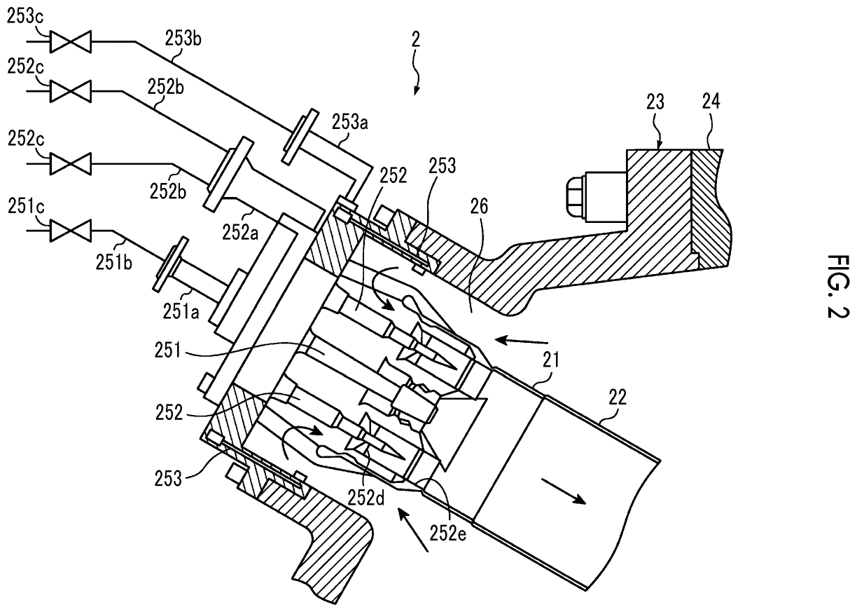

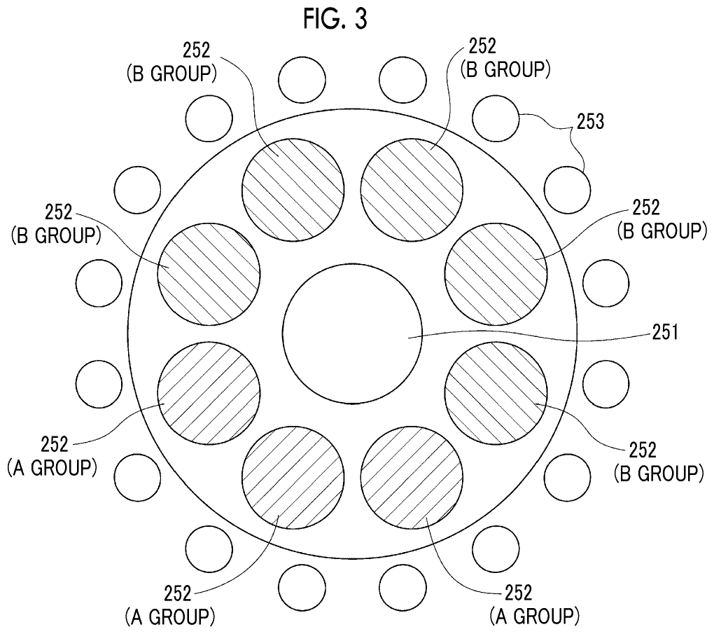

First, a configuration of a gas turbine GT which is a control target of a gas turbine control device according to at least one embodiment of the present invention will be described with reference to FIGS. 1 to 3. FIG. 1 is a schematic configuration diagram of the gas turbine GT according to an embodiment, FIG. 2 is a schematic configuration diagram of a combustor 2 of the gas turbine GT of FIG. 1, and FIG. 3 is a schematic cross-sectional view of FIG. 2.

As shown in FIG. 1, the gas turbine GT includes a compressor 1, the combustor 2, and a turbine 3. The rotor 4 is disposed to penetrate central portions of the compressor 1, the combustor 2, and the turbine 3. The compressor 1, the combustor 2, and the turbine 3 are arranged in order from a front side to a rear side of a flow of air along an axial center R of the rotor 4.

In the following description, an axial direction is a direction parallel to the axial center R, and a circumferential direction is a direction rotating around the axial center R.

The compressor 1 is configured to compress air to generate compressed air. The compressor 1 is provided with a compressor stator vane 13 and a compressor rotor blade 14 in a compressor casing 12 having an air intake port 11 for taking in air. The compressor stator vanes 13 are attached to the compressor casing 12 side and are arranged in a plurality in the circumferential direction. The compressor rotor blades 14 are attached to the rotor 4 side and are arranged in a plurality in the circumferential direction. The compressor stator vanes 13 and the compressor rotor blades 14 are alternately provided along the axial direction.

The combustor 2 is configured to generate a high-temperature and high-pressure combustion gas by supplying fuel to the compressed air compressed by the compressor 1. The combustor 2 includes an inner cylinder 21 that serves as a combustion cylinder and in which compressed air and fuel are mixed and combusted, a transition piece 22 that guides combustion gas from the inner cylinder 21 to the turbine 3, and an outer cylinder 23 that covers an outer periphery of the inner cylinder 21 and forms an air passage 26 (see FIG. 2) that guides compressed air from the compressor 1 to the inner cylinder 21. A plurality of (for example, 16) combustors 2 are arranged in the circumferential direction with respect to a combustor casing 24. The configuration of the combustor 2 is referred to as a cannular type.

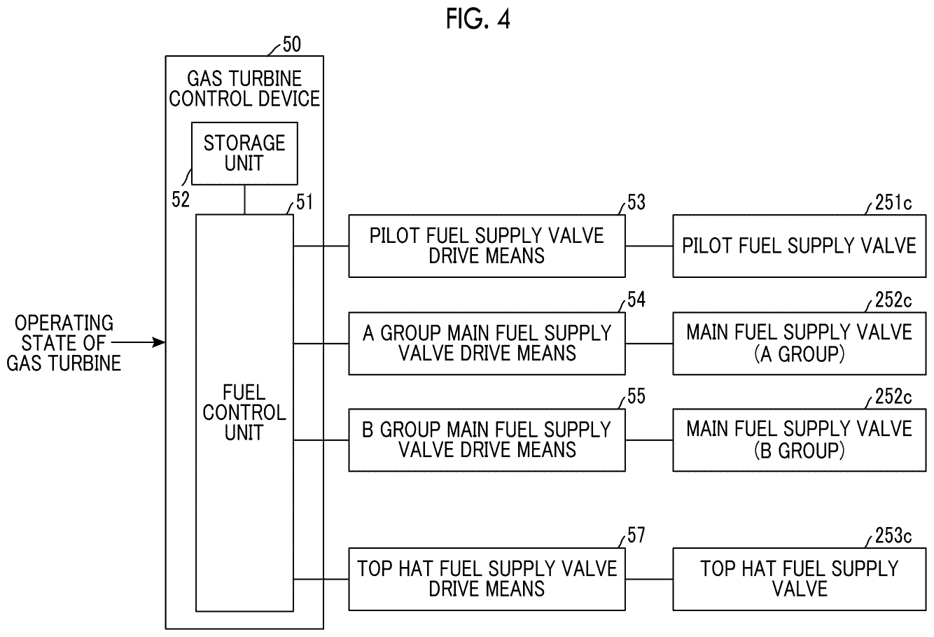

As shown in FIGS. 2 and 3, each of the combustors 2 is provided with a pilot nozzle 251, a main nozzle 252, and a top hat nozzle 253 as nozzles for supplying fuel. One pilot nozzle 251 is provided at a center of the inner cylinder 21. A pilot fuel line 251b is connected to a fuel port 251a of the pilot nozzle 251, the fuel port 251a being provided on an outside of the combustor 2. The pilot fuel line 251b is provided with a pilot fuel supply valve 251c. That is, by bringing the pilot fuel supply valve 251c into an open state, the fuel is supplied to the pilot nozzle 251 and the fuel is injected from the pilot nozzle 251. In addition, the fuel supply amount of the pilot fuel supply valve 251c in the open state is configured to be variable. On the other hand, by bringing the pilot fuel supply valve 251c into a closed state, the supply of the fuel to the pilot nozzle 251 is stopped and the fuel injection from the pilot nozzle 251 is stopped. The pilot fuel supply valve 251c is driven to be opened and closed by a pilot fuel supply valve drive unit 53 (see FIG. 4) such as an actuator or a motor.

A plurality of (in the present example, eight) main nozzles 252 are provided to be adjacent to each other in the circumferential direction around the pilot nozzle 251 in the inner cylinder 21. The main nozzles 252 are configured to be divided into a plurality of groups. In the present embodiment, as shown in FIG. 3, the eight main nozzles 252 are configured to include an A group including three main nozzles 252 adjacent to each other along the circumferential direction and a B group including the remaining five main nozzles 252 adjacent to each other along the circumferential direction.

In the present embodiment, a case where the plurality of main nozzles 252 are divided into two groups (A group and B group) has been described as an example. However, the number of groups into which the plurality of main nozzles 252 are divided may be two or more. In addition, in the present embodiment, a case where the number (five) of the main nozzles 252 belonging to the B group is larger than the number (three) of the main nozzles 252 belonging to the A group has been described as an example. However, the numerical relationship between the numbers of the main nozzles 252 belonging to the A group and the B group may be optional. In addition, in the present embodiment, a case where the numbers of the main nozzles 252 belonging to the A group and the B group are different from each other has been described as an example. However, the numbers of the main nozzles 252 belonging to the A group and the B group may be the same.

Each of the main nozzles 252 divided into the A group and the B group is connected to main fuel line 252b corresponding to each group to a fuel port 252a extended to the outside of the combustor 2. Each of the main fuel lines 252b is provided with a main fuel supply valve 252c. That is, by bringing each of the main fuel supply valves 252c into an open state, the fuel is supplied to the main nozzles 252 of each group and the fuel is injected from the main nozzles 252 of each group. In addition, the fuel supply amount of each of the main fuel supply valves 252c in the open state is configured to be variable. On the other hand, by bringing each of the main fuel supply valves 252c into a closed state, the supply of the fuel to the main nozzles 252 of each group is stopped and the injection of the fuel from the main nozzles 252 of each group is stopped. The main fuel supply valves 252c of each of the groups are driven to be opened and closed by an A group main fuel supply valve drive unit 54 and a B group main fuel supply valve drive unit 55 (see FIG. 4) such as an actuator or a motor. In addition, a swirling blade 252d is provided on an outside of the main nozzle 252, and the periphery of the swirling blade 252d is covered with a burner cylinder 252e.

A plurality of (in the present example, sixteen) top hat nozzles 253 are provided to be adjacent to each other in the circumferential direction further around the main nozzles 252 along an inner peripheral surface of the outer cylinder 23. A top hat fuel line 253b is connected to a fuel port 253a of the top hat nozzle 253, the fuel port 253a being provided on the outside of the combustor 2. The top hat fuel line 253b is provided with a top hat fuel supply valve 253c. That is, by bringing the top hat fuel supply valve 253c into an open state, the fuel is supplied to the top hat nozzle 253 and the fuel is injected from the top hat nozzle 253. In addition, the fuel supply amount of the top hat fuel supply valve 253c in the open state is configured to be variable. On the other hand, by bringing the top hat fuel supply valve 253c into a closed state, the fuel supply to the top hat nozzle 253 is stopped and the fuel injection from the top hat nozzle 253 is stopped. The top hat fuel supply valve 253c is driven to be opened and closed by a top hat fuel supply valve drive unit 57 (see FIG. 4) such as an actuator or a motor.

In the combustor 2 having such a configuration, as shown in FIG. 2, the air flow of the high-temperature and high-pressure compressed air flows into the air passage 26. The fuel injected from the top hat nozzle 253 is mixed with the compressed air, so that a fuel-air mixture is generated and flows into the inner cylinder 21. In the inner cylinder 21, the fuel injected from the main nozzle 252 is mixed with the fuel-air mixture, and becomes a swirling flow of the premixed gas in the swirling blade 252d and the burner cylinder 252e, and flows into the transition piece 22. In addition, the fuel-air mixture is mixed with the fuel injected from the pilot nozzle 251, is ignited and combusted by a pilot flame (not shown), and is injected into the transition piece 22 as combustion gas. At this time, a part of the combustion gas is injected to the inside of the transition piece 22 to diffuse to the periphery with the flame, and is ignited and combusted by the premixed gas from the burner cylinder 252e of each main nozzle 252. That is, the flame holding is performed to stabilize the combustion of the premixed gas from the burner cylinder 252e of each main nozzle 252 by the diffused flame caused by the fuel injected from the pilot nozzle 251.

Returning to FIG. 1, the turbine 3 generates rotational power by means of the combustion gas combusted in the combustor 2. The turbine 3 includes a turbine stator vane 32 and a turbine rotor blade 33 in a turbine casing 31. The turbine stator vanes 32 are attached to the turbine casing 31 side and are arranged in a plurality in the circumferential direction. The turbine rotor blades 33 are attached to the rotor 4 side and are arranged in a plurality in the circumferential direction. The turbine stator vanes 32 and the turbine rotor blades 33 are alternately provided along the axial direction. In addition, an exhaust chamber 34 having an exhaust diffuser 34a continuous with the turbine 3 is provided on a rear side of the turbine casing 31.

The rotor 4 is rotatable around the axial center R with an end portion on the compressor 1 side supported by a bearing portion 41 and an end portion on the exhaust chamber 34 side supported by a bearing portion 42. A drive shaft of a generator (not shown) is connected to an end portion of the compressor 1 on the bearing portion 41 side.

In the gas turbine GT, the air taken in from the air intake port 11 of the compressor 1 is compressed by passing through the plurality of compressor stator vanes 13 and the compressor rotor blades 14, and becomes high-temperature and high-pressure compressed air. The compressed air is supplied with fuel by the pilot nozzle 251, the main nozzle 252, and the top hat nozzle 253 of the combustor 2, so that high-temperature and high-pressure combustion gas is generated. Then, the rotor 4 is rotationally driven by the combustion gas passing through the turbine stator vane 32 and the turbine rotor blade 33 of the turbine 3, and power generation is performed by applying rotational power to a generator connected to the rotor 4. Then, the exhaust gas after the rotor 4 is rotationally driven is converted into a static pressure by the exhaust diffuser 34a of the exhaust chamber 34, and is then discharged to the atmosphere.

Subsequently, a gas turbine control device 50 for controlling the gas turbine GT having the above configuration will be described. FIG. 4 is a block configuration diagram showing the gas turbine control device 50 according to the embodiment.

The gas turbine control device 50 is configured to control the gas turbine GT, and is configured by, for example, a microcomputer or the like. As shown in FIG. 4, the gas turbine control device 50 includes a fuel control unit 51 and a storage unit 52. When the operating state of the gas turbine GT (for example, a load index CLCSO or an intake air temperature TIC of the gas turbine GT) is input to the gas turbine control device 50, the fuel control unit 51 controls the pilot fuel supply valve drive unit 53, the A group main fuel supply valve drive unit 54, the B group main fuel supply valve drive unit 55, and the top hat fuel supply valve drive unit 57 to supply fuel to the pilot nozzle 251, the main nozzle 252, and the top hat nozzle 253 according to a program or data stored in advance in the storage unit 52.

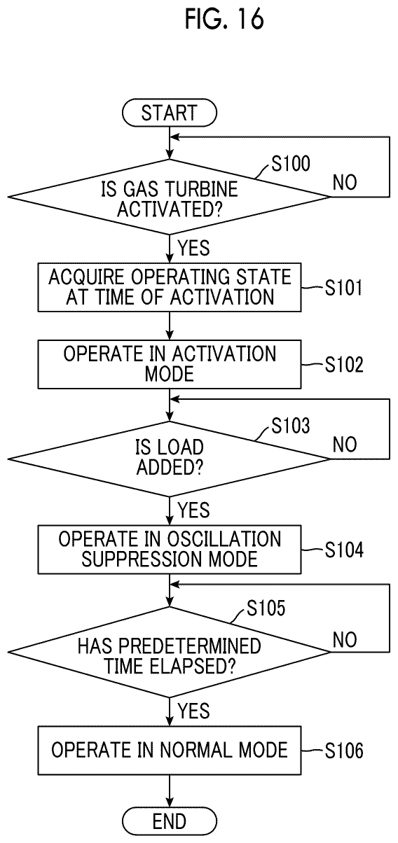

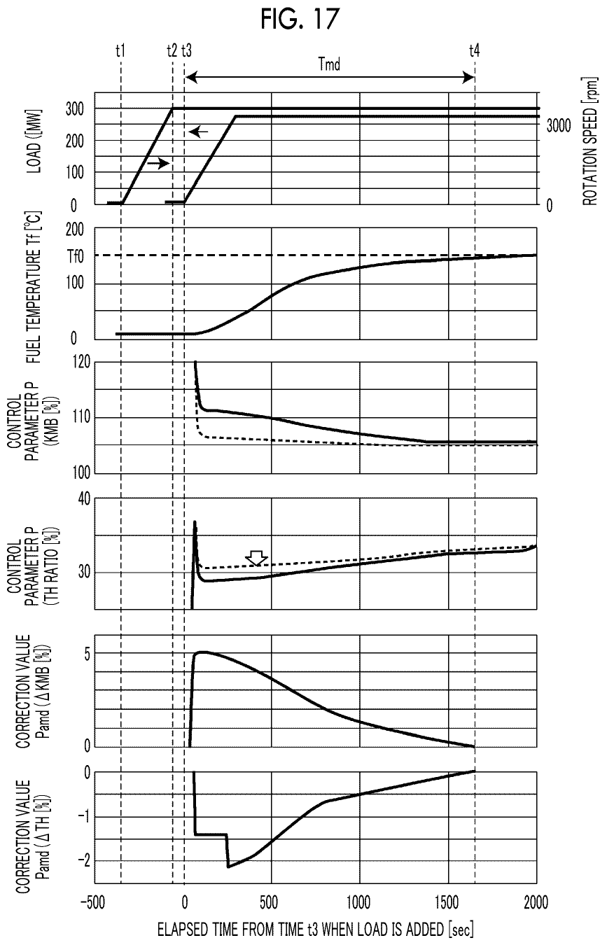

As an operation mode for controlling the gas turbine GT, the gas turbine control device 50 can perform an activation mode, an oscillation suppression mode, and a normal mode as will be described later with reference to FIGS. 16 and 17. The activation mode is an operation mode for increasing the rotation speed of the gas turbine GT in a stopped state to the rated rotation speed when the gas turbine GT is activated, and for bringing the gas turbine GT into a state where the load can be added. The oscillation suppression mode is an operation mode for suppressing an increasing risk of occurrence of combustion oscillation in a case where the fuel temperature is low when a load is added to the gas turbine GT after the activation mode. The normal mode is an operation mode for normally operating the gas turbine GT through the activation mode and a combustion oscillation mode.

In the gas turbine GT having the above configuration, as a configuration for supplying the fuel, the gas turbine GT has the pilot nozzle 251, the main nozzles 252 divided into the A group and the B group, and the top hat nozzle 253. The fuel control unit 51 divides these configurations into a first group G1 and a second group G2, and performs the fuel supply control using a ratio of the fuel supply amount by the second group G2 to the fuel supply amount by the first group G1 as a control parameter P. For example, in a case where the main nozzles 252 divided into the A group and the B group are respectively treated as the first group G1 and the second group G2, a ratio KMB of a fuel supply amount MB of the main nozzles 252 belonging to the B group to a fuel supply amount MA of the main nozzles 252 belonging to the A group is treated as the control parameter P. Specifically, in a case where the total number of the main nozzles 252 is 8 as described above and the number of the main nozzles 252 belonging to the A group and the B group is 3 and 5, respectively, the KMB is defined by the following equation.

$$KMB = MB / ( MA + M B ) \times ( 8 / 5 ) \times 100$$

The KMB defined as described above is an index that becomes “100%” in a case where an equal fuel supply amount is distributed to each of the plurality of main nozzles 252 (that is, in a case of MA:MB=3:5).

The first group G1 and the second group G2 can be optionally selected from the pilot nozzle 251, the main nozzles 252 divided into the A group and the B group, and the top hat nozzle 253. For example, the ratio of the fuel supply amount between the main nozzles 252 and the top hat nozzle 253 may be treated as the control parameter P by selecting the main nozzles 252 including the A group and the B group as the first group G1 and selecting the top hat nozzle 253 as the second group G2.

Next, a configuration of each of the operation modes for calculating the control parameter P via the fuel control unit 51 will be described.

First, in the activation mode, the fuel control unit 51 performs control to supply the fuel to five main nozzles 252 belonging to the B group out of the eight main nozzles 252. At this time, the three main nozzles 252 belonging to the A group are controlled such that the fuel supply amount is increased by supplying the fuel supplied to the eight main nozzles 252 in the normal mode. Accordingly, a large flame is generated by the main nozzles 252 belonging to the A group, and quick activation is possible.

In the oscillation suppression mode, the fuel control unit 51 calculates a base index Pbase and a correction value Pamd with respect to the control parameter P such as the KMB or a TH ratio, and treats a result obtained by correcting the base index Pbase with the correction value Pamd as the control parameter P. As a result, even in a case where the fuel temperature is low, the operating state of the gas turbine GT can be shifted from a state where combustion oscillation is likely to occur, and a control tolerance can be ensured even during a rapid activation in which the fuel temperature is low, and combustion oscillation can be effectively suppressed.

In the normal mode, control corresponding to a case where the correction value Pamd in the oscillation suppression mode is set to zero is performed. That is, the base index Pbase calculated in the oscillation suppression mode corresponds to the control parameter P itself in the normal mode.

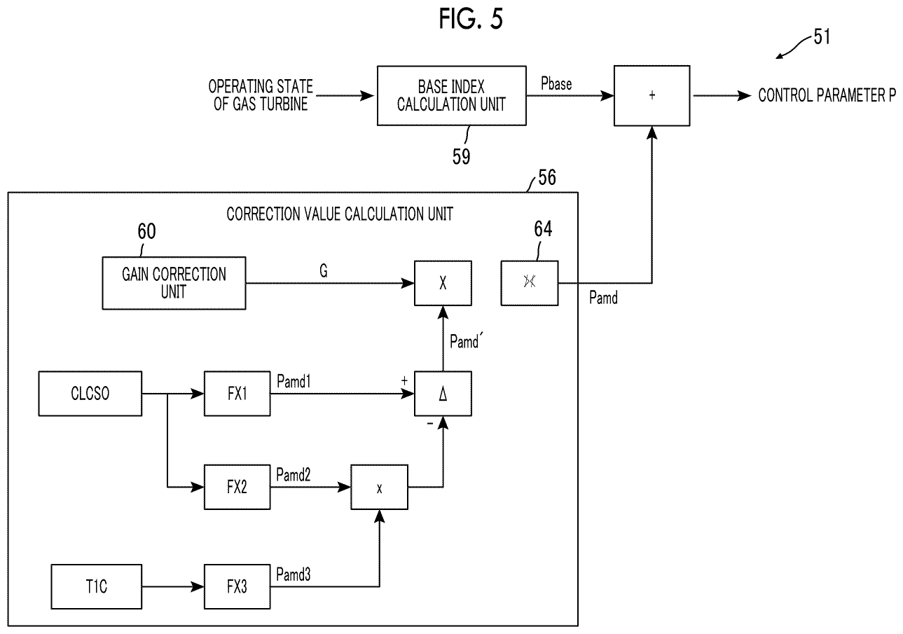

Here, FIG. 5 is a processing flowchart of the fuel control unit 51 of FIG. 4 in the oscillation suppression mode. The fuel control unit 51 includes a base index calculation unit 59 and a correction value calculation unit 56.

The base index calculation unit 59 is configured to calculate the base index Pbase related to the control parameter P based on the operating state of the gas turbine GT. The base index calculation unit 59 acquires, for example, the load index CLCSO of the gas turbine GT as the operating state of the gas turbine GT. These are acquired based on various sensors and control signals installed in the gas turbine GT. The relationship between the operating state of the gas turbine GT and the base index Pbase is defined in advance as a function, and the base index calculation unit 59 calculates the base index Pbase by inputting the operating state of the gas turbine GT into the function.

The correction value calculation unit 56 is configured to calculate the correction value Pamd for correcting the base index Pbase calculated by the base index calculation unit 59, based on the operating state of the gas turbine GT. In the present embodiment, as the operating state of the gas turbine GT input to the correction value calculation unit 56, the load index CLCSO corresponding to the load of the gas turbine GT and the intake air temperature TIC of the gas turbine GT are input. The relationship between the operating state of the gas turbine GT and the correction value Pamd is defined in advance as at least one function, and the correction value Pamd is calculated to be zero at a time when a predetermined period elapses from the time when the load is added.

The intake air temperature TIC is detected by a temperature sensor provided in an intake air chamber 11 of the gas turbine GT, for example, as shown in FIG. 1.

When a specific processing flow for calculating the correction value Pamd is described according to FIG. 5, the load index CLCSO and the intake air temperature TIC acquired as the operating state of the gas turbine GT are input to a first function FX1, a second function FX2, and a third function FX3. The first function FX1, the second function FX2, and the third function FX3 stored in the storage unit 52 in advance are read out.

The load index CLCSO acquired as the operating state of the gas turbine GT is input to the first function FX1, and a first correction value Pamd1 is output. The first function FX1 is set in advance as a function indicating a correlation between the load index CLCSO and the first correction value Pamd1, and is stored in the storage unit 52. The correction value calculation unit 56 reads out the first function FX1 from the storage unit 52 and calculates the first correction value Pamd1 by inputting the load index CLCSO acquired as the operating state of the gas turbine GT.

The load index CLCSO acquired as the operating state of the gas turbine GT is input to the second function FX2, and a second correction value Pamd2 is output. The second function FX2 is set in advance as a function indicating a correlation between the load index CLCSO and the second correction value Pamd2, and is stored in the storage unit 52. The correction value calculation unit 56 reads out the second function FX2 from the storage unit 52 and calculates the second correction value Pamd2 by inputting the load index CLCSO acquired as the operating state of the gas turbine GT.

The intake air temperature TIC acquired as the operating state of the gas turbine GT is input to the third function FX3, and a third correction value Pamd3 is output. The third function FX3 is set in advance as a function indicating a correlation between the intake air temperature TIC and the third correction value Pamd3, and is stored in the storage unit 52. The correction value calculation unit 56 reads out the third function FX3 from the storage unit 52 and calculates the third correction value Pamd3 by inputting the intake air temperature TIC acquired as the operating state of the gas turbine GT.

The correction value calculation unit 56 calculates a temporary correction value Pamd′ based on the first correction value Pamd1, the second correction value Pamd2, and the third correction value Pamd3. As shown in FIG. 5, the temporary correction value Pamd′ is calculated as a difference between the first correction value Pamd1 and the multiplication result of the second correction value Pamd2 and the third correction value Pamd3.

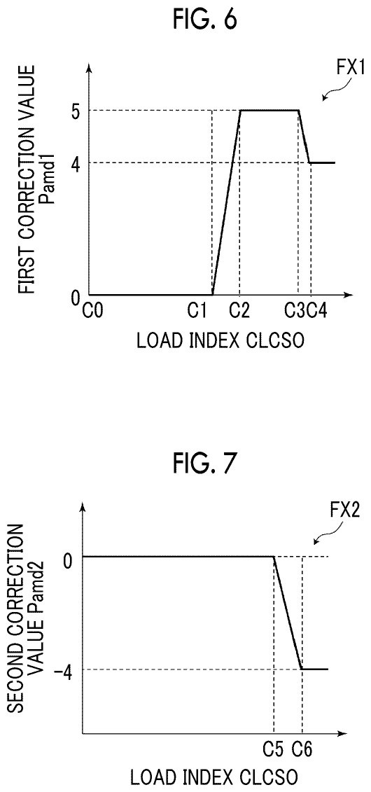

Here, FIGS. 6 to 8 are examples of the first function FX1 to the third function FX3 in a case where KMB is treated as the control parameter P. As shown in FIG. 6, the first function FX1 is set such that the first correction value Pamd1 increases in a range corresponding to the target load band to be corrected with respect to the load index CLCSO. In the present embodiment, the first function FX1 is set such that the first correction value Pamd1 is zero when the load index CLCSO is between C0 and C1, the first correction value Pamd1 gradually increases when the load index CLCSO is between C1 and C2, the first correction value Pamd1 is substantially constant “5” when the load index CLCSO is between C2 and C3, the first correction value Pamd1 gradually decreases when the load index CLCSO is between C3 and C4, and the first correction value Pamd1 is substantially constant “4” when the load index CLCSO is at C4 or more.

As shown in FIG. 7, the second function FX2 is set such that the second correction value Pamd2 increases in a range corresponding to the target load band to be corrected with respect to the load index CLCSO. In the present embodiment, the second function FX2 is set such that the second correction value Pamd2 is substantially constant “0” when the load index CLCSO is at C5 or less, the second correction value Pamd2 gradually decreases when the load index CLCSO is between C5 and C6, and the second correction value Pamd2 is substantially constant “−4” when the load index CLCSO is at C6 or more.

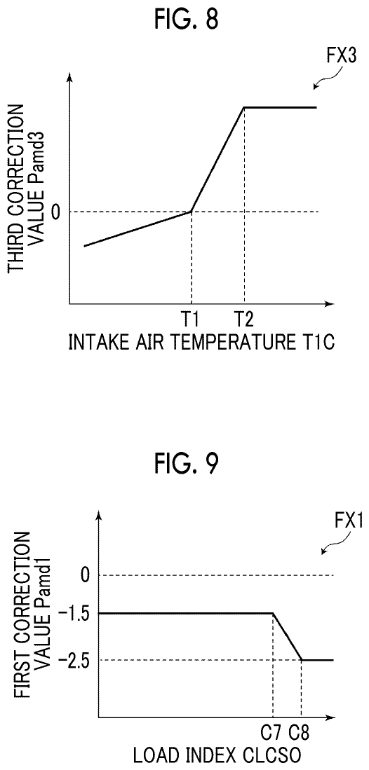

As shown in FIG. 8, the third function FX3 is set such that the third correction value Pamd3 increases in a range corresponding to the target temperature band to be corrected with respect to the intake air temperature TIC. In the present embodiment, the third function FX3 is set such that the third correction value Pamd3 gradually increases when the intake air temperature TIC is T1 or lower, the third correction value Pamd3 more rapidly increases when the intake air temperature TIC is between T1 and T2, and the third correction value Pamd3 is substantially constant when the intake air temperature TIC is T2 or higher.

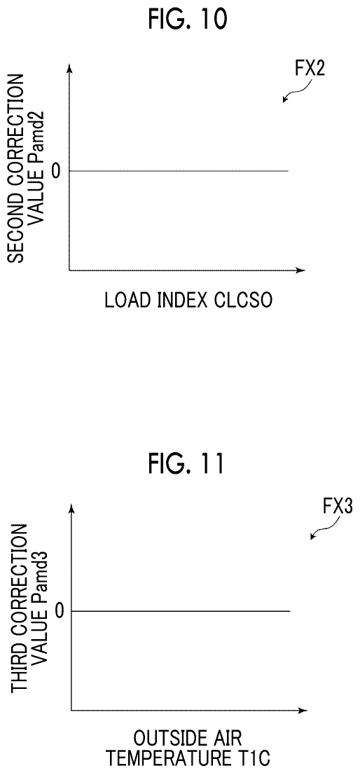

In addition, FIGS. 9 to 11 are examples of the first function FX1 to the third function FX3 in a case where the TH ratio is treated as the control parameter P. In this case, as shown in FIG. 9, the first function FX1 is set such that the first correction value Pamd1 is substantially constant “−1.5” when the load index CLCSO is at C7 or less, the first correction value Pamd1 gradually decreases when the load index CLCSO is between C7 to C8, and the first correction value Pamd1 is substantially constant “−2.5” when the load index CLCSO is at C8 or more. In addition, as shown in FIG. 10, the second function FX2 is set to be substantially constant “0” regardless of the load index CLCSO. In addition, as shown in FIG. 11, the third function FX3 is set to be substantially constant “0” regardless of the intake air temperature TIC.

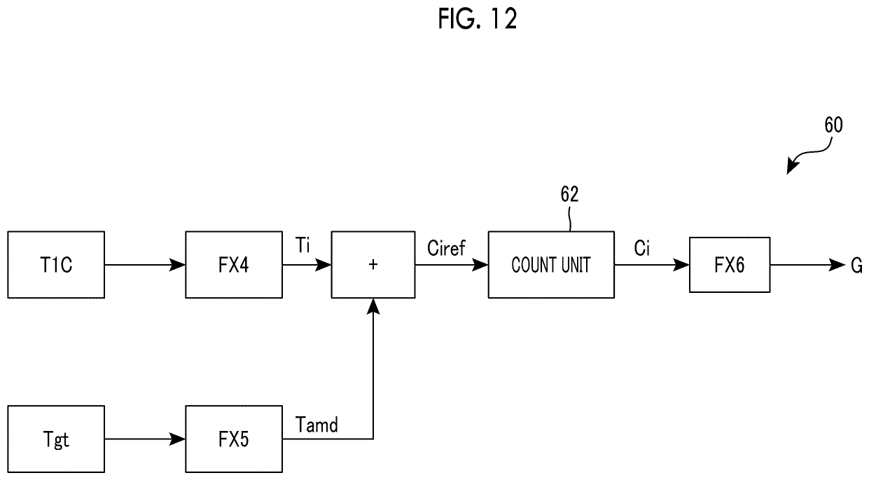

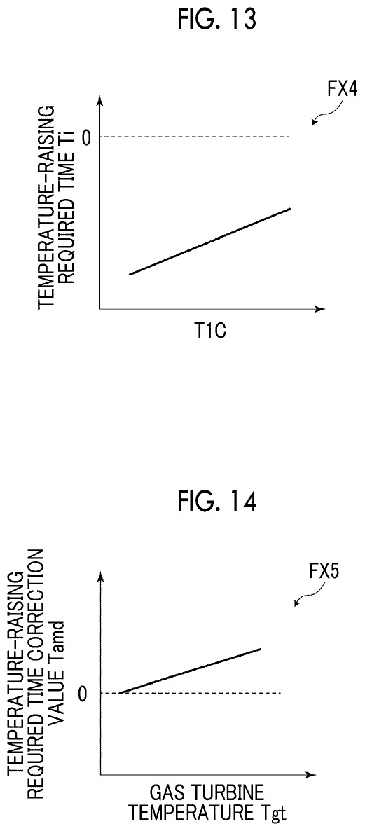

A gain correction coefficient G calculated by a gain correction unit 60 is multiplied by the temporary correction value Pamd′ calculated using the first function FX1 to the third function FX3 in this way, so that the temporary correction value Pamd′ is adjusted to be zero at the time when the predetermined period elapses from the when the load is added. Here, FIG. 12 is a processing flowchart of the gain correction unit 60 of FIG. 5, and FIGS. 13 to 15 are diagrams showing a fourth function FX4 to a sixth function FX6 of FIG. 5.

The gain correction unit 60 inputs the intake air temperature TIC acquired as the operating state of the gas turbine GT to the fourth function FX4 to calculate a temperature-raising required time Ti (for example, the time until the fuel temperature reaches a target temperature set in advance) required for the fuel temperature to be sufficiently raised. The relationship between the intake air temperature TIC and the temperature-raising required time Ti is stored in the storage unit 52 in advance as a fourth function FX4. For example, as shown in FIG. 13, the fourth function FX4 is defined such that the temperature-raising required time Ti monotonically increases with respect to the intake air temperature TIC. The gain correction unit 60 reads out a fifth function FX5 stored in the storage unit 52 and inputs the intake air temperature TIC acquired as the operating state of the gas turbine GT to the fifth function FX5 to calculate the temperature-raising required time Ti.

In addition, the gain correction unit 60 calculates a temperature-raising required time correction value Tamd for correcting the temperature-raising required time Ti based on the temperature (second stage DC (disk cavity) temperature Tgt) of the gas turbine GT acquired as the operating state of the gas turbine GT at the time of activation. The second stage DC temperature Tgt is acquired as a detection value by a temperature sensor installed in a cavity of a second stage disk of the gas turbine GT. The relationship between the second stage DC temperature Tgt and the temperature-raising required time correction value Tamd is stored in the storage unit 52 in advance as the fifth function FX5. For example, as shown in FIG. 14, the fifth function FX5 is defined such that the temperature-raising required time correction value Tamd monotonically increases with respect to the second stage DC temperature Tgt. The gain correction unit 60 reads out the fifth function FX5 stored in the storage unit 52 and inputs the second stage DC temperature Tgt to the sixth function FX6 to calculate the temperature-raising required time correction value Tamd.

The gain correction unit 60 obtains a count reference value Ciref as a result of adding the temperature-raising required time correction value Tamd to the temperature-raising required time Ti and correcting the value. As can be seen from a comparison between the fourth function FX4 and the fifth function FX5 shown in FIGS. 13 and 14, since the temperature-raising required time Ti calculated from the fourth function FX4 is a negative value having an absolute value larger than the temperature-raising required time correction value Tamd calculated from the fifth function FX5, typically, the count reference value Ciref is a negative value. A count unit 62 counts up such a count reference value Ciref by a unit value per unit time (for example, by counting up by one every second) and outputs a count index Ci.

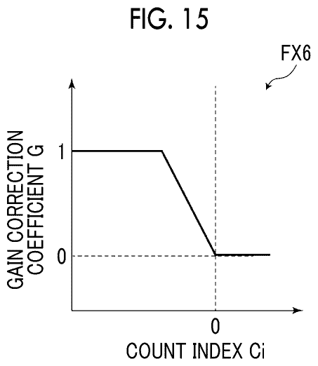

The count index Ci output from the count unit 62 is input to the sixth function FX6. The relationship between the count index Ci and the gain correction coefficient G is stored in the storage unit 52 in advance as the sixth function FX6. As shown in FIG. 15, the sixth function FX6 is set such that the gain correction coefficient G is a substantially constant value “1” in a case where the count index Ci is a sufficiently small negative value, the gain correction coefficient G monotonically decreases as the count index Ci approaches zero, and the gain correction coefficient G becomes “zero” when the count index Ci becomes zero.

The gain correction coefficient G calculated by the gain correction unit 60 is multiplied by the above-described temporary correction value Pamd′ to obtain the correction value Pamd that transitions so that the absolute value thereof becomes zero at the time when a predetermined period elapses from the time when the load is added. Accordingly, when the fuel temperature rises and the combustion oscillation risk is reduced, the control of the gas turbine GT (normal mode) based on the original base index Pbase can be smoothly shifted.

In addition, in FIG. 5, a limiter 64 is provided to prevent the correction value Pamd from deviating from an allowable range set in advance.

Next, a method for activating the gas turbine GT by means of the gas turbine control device 50 having the above configuration will be described. FIG. 16 is a flowchart showing a gas turbine activation method according to the embodiment, and FIG. 17 is a time chart showing a change over time of various indices related to an operating state of the gas turbine GT at the time of activation.

First, the gas turbine control device 50 determines whether or not the gas turbine GT has been activated (step S100). In step S100, for example, it is determined whether or not the gas turbine GT is activated based on whether or not an activation switch provided in the gas turbine GT is turned on by an operator. In a case where the gas turbine GT is activated (step S100: YES), the gas turbine control device 50 acquires the operating state of the gas turbine GT at the time of activation (step S101), and performs the activation mode as the operation mode of the gas turbine GT (step S102). The operating state acquired in step S101 includes at least the fuel temperature at the time of activation, and in FIG. 17, it is indicated that a fuel temperature Tf is sufficiently low with respect to a target fuel temperature Tf0 at the time t1 which is the time of activation.

In the activation mode performed in step S102, activation operation is performed by supplying the fuel to the three main nozzles 252 belonging to the A group out of the eight main nozzles 252. In this case, the fuel is supplied to the three main nozzles 252 belonging to the A group with respect to the eight main nozzles 252 in the normal mode. In this manner, the fuel supply amount is increased from the normal mode, and the flame to be generated is also increased. As a result, as shown in FIG. 17, when the gas turbine GT is activated at time t1, the rotation speed of the gas turbine GT gradually increases and reaches the rated rotation speed at time t2.

Subsequently, the gas turbine control device 50 determines whether or not the load is added to the gas turbine GT (step S103). The load is added to the gas turbine GT at the time of activation after the rotation speed of the gas turbine GT has been increased to the rated rotation speed. In FIG. 17, a state where the load is added to the gas turbine GT is shown at time t3 after the rotation speed of the gas turbine GT reaches the rated rotation speed at time t2.

When the load is added to the gas turbine GT (step S103: YES), the gas turbine control device 50 shifts the operation mode of the gas turbine GT to the oscillation suppression mode (step S104). As described above, in the oscillation suppression mode, the gas turbine GT is controlled based on the control parameter P (the ratio of the fuel supply amount by the second group G2 to the fuel supply amount by the first group G1) obtained by correcting the base index Pbase calculated by the base index calculation unit 59 with the correction value Pamd calculated by the correction value calculation unit 56. In FIG. 17, the KMB and the TH ratio (as a result of the base index Pbase being corrected by the correction value Pamd) are shown by solid lines as the control parameters P. In addition, in FIG. 17, for comparison, the control parameter (that is, the base index Pbase itself) before being corrected by the correction value Pamd is shown by a broken line. Since the KMB, which is the control parameter P, is used to obtain the correction value Pamd having a positive sign by using the first function FX1 to the third function FX3 shown in FIGS. 6 to 8, the control parameter P is corrected to be larger than the base index Pbase (the solid line is larger than the broken line). On the other hand, since the TH ratio, which is the control parameter P, is used to obtain the correction value Pamd having a negative sign by using the first function FX1 to the third function FX shown in FIGS. 9 to 11, the control parameter P is corrected to be smaller than the base index Pbase (the broken line is smaller than the solid line). In this way, the control parameter P is obtained by correcting the base index Pbase calculated based on the operating state using the correction value Pamd, and thus the operating state of the gas turbine GT can be shifted from the state where combustion oscillation is likely to occur. Therefore, the control tolerance can be ensured even during the rapid activation in which the fuel temperature is low, and the combustion oscillation can be effectively suppressed.

In addition, as described above, the correction value Pamd is calculated such that the absolute value thereof decreases to zero at the time t4 when a predetermined period Tmd elapses from the time when the load is added (time t3). Therefore, in FIG. 17, a behavior in which the correction value Pamd (ΔKMB) having a positive sign corresponding to the KMB gradually decreases so as to be zero at time t4 is shown. On the other hand, in FIG. 17, a behavior in which the correction value Pamd (ΔTH) having a negative sign corresponding to the TH ratio gradually increases so as to be zero at time t4 is shown.

Subsequently, the gas turbine control device 50 determines whether or not the predetermined period Tmd elapses from the time when the load is added (time t3) (step S105). The predetermined period Tmd is set as a period in which the correction value Pamd to be added to the base index Pbase in the oscillation suppression mode of step S104 decreases and reaches zero. When the predetermined period Tmd elapses from the time when the load is added (time t3) (step S105: YES), the correction value Pamd added to the base index Pbase in the oscillation suppression mode becomes zero. Therefore, the gas turbine control device 50 shifts the operation mode of the gas turbine GT to the normal mode (step S106) and completes the series of activation controls. Accordingly, when the fuel temperature rises and the combustion oscillation risk is reduced, the gas turbine GT can be smoothly shifted to the normal mode based on the original base index Pbase.

According to the above embodiment, the gas turbine control device, the gas turbine control method, and the gas turbine control program capable of suppressing the occurrence of combustion oscillation even in a case where the load is added in a state where the fuel temperature is low can be provided.

In addition, it is possible to appropriately replace the components in the embodiment described above with well-known components within the scope which does not depart from the gist of the present disclosure, and the embodiments described above may be combined appropriately.

For example, contents described in each of the above-described embodiments are understood as follows.

(1) A gas turbine control device according to one aspect is a gas turbine control device (50) for controlling a gas turbine (GT) in which a combustor (2) is configured in a form in which a plurality of fuel supply nozzles for supplying fuel are divided into a first group (G1) and a second group (G2), the gas turbine control device including a base index calculation unit (59) for calculating a base index (Pbase) of a control parameter (P) regarding a ratio of a fuel supply amount by the second group to a fuel supply amount by the first group, based on an operating state of the gas turbine, a correction value calculation unit (56) for calculating a correction value (Pamd) for correcting the base index, based on the operating state of the gas turbine, and a fuel control unit (51) for controlling each of the fuel supply amounts by the first group and the second group, based on the control parameter obtained by correcting the base index using the correction value, in which the correction value calculation unit calculates the correction value such that an absolute value of the correction value decreases to zero, when a predetermined period (Tmd) elapses from a time when a load is added to the gas turbine after the gas turbine is activated.

According to the aspect of the above (1), the fuel supply control of the gas turbine is performed by using the control parameter related to the ratio of the fuel supply amount by the first group and the second group. In this way, the control parameter is obtained by correcting the base index calculated based on the operating state using the correction value, and thus the operating state of the gas turbine can be shifted from the state where combustion oscillation is likely to occur. Therefore, the control tolerance can be ensured even during the rapid activation in which the fuel temperature is low, and the combustion oscillation can be effectively suppressed. The correction value is calculated such that the absolute value of the correction value decreases to zero when a predetermined period elapses from the time when the load is added to the gas turbine, and thus the control of the gas turbine based on the original base index can be smoothly shifted when the fuel temperature rises and the combustion oscillation risk is reduced. As a result, even in a case where the fuel temperature is low as in the rapid activation, the combustion oscillation can be suitably suppressed.

(2) In another aspect, in the aspect of the above (1), the predetermined period is set based on a temperature-raising required time (Ti) of the fuel and on a temperature (Tgt) of the gas turbine at a time of activating the gas turbine.

According to the aspect of the above (2), the elapsed time required for the correction value for correcting the base index to be reduced to zero is set based on the fuel temperature-raising required time (time required for raising the temperature of the low-temperature fuel to the target temperature) or on the activation temperature of the gas turbine. Accordingly, for example, in a case where it is estimated that the fuel temperature is low due to the fact that the temperature of the gas turbine or the intake air temperature is low, the combustion oscillation can be suitably suppressed by setting the predetermined time to be long and by ensuring that the period in which the base index is corrected by the correction value is long.

(3) In another aspect, in the aspect of the above (1) or (2), the correction value is calculated based on an intake air temperature (TIC) of the gas turbine.

According to the aspect of the above (3), the correction value for correcting the base index is calculated based on the intake air temperature of the gas turbine. Accordingly, for example, the correction value is calculated to be large in a case where the intake air temperature is low, so that the combustion oscillation which is likely to occur in a case where the fuel temperature is low can be suitably suppressed.

(4) In another aspect, in any one aspect of the above (1) to (3), the plurality of fuel supply nozzles include a plurality of main nozzles (252) that are disposed at intervals in a circumferential direction to supply fuel to a plurality of main burners, the plurality of main nozzles are divided into an A group and a B group, and the control parameter is KMB, which is a ratio of a fuel supply amount of the main nozzle of the B group selected as the second group to a fuel supply amount of the main nozzle of the A group selected as the first group.

According to the aspect of the above (4), the plurality of main nozzles included in the combustor are divided into the first group and the second group, and the KMB, which is the fuel supply ratio of the first group to the second group, is set as the base index. By applying the correction value to the base index, combustion oscillation can be suitably suppressed.

(5) In another aspect, in the aspect of the above (4), the correction value is calculated to increase the base index.

According to the aspect of the above (5), the difference between the size of the flame formed by the main burner belonging to the first group and the size of the flame formed by the main burner belonging to the second group is increased by correcting the base index to be increased. In this manner, combustion oscillation which is likely to occur in a case where the fuel temperature is low can be suitably suppressed.

(6) In another aspect, in the aspect of the above (4) or (5), the numbers of the main nozzles belonging to the first group and the second group are different from each other.

According to the aspect of the above (6), the main nozzles having different numbers belong to the first group and the second group, so that an asymmetric flame is formed in the combustor, and thus combustion oscillation can be suppressed.

(7) In another aspect, in any one aspect of the above (1) to (3), the plurality of fuel supply nozzles include a plurality of main nozzles (252) that are disposed at intervals in a circumferential direction to supply fuel to a plurality of main burners, and a plurality of top hat nozzles (253) that supply fuel to fuel introduction paths of the plurality of main burners, and the control parameter is a ratio of fuel supply amounts of the plurality of top hat nozzles selected as the second group to fuel supply amounts of the plurality of main nozzles selected as the first group.

According to the aspect of the above (7), the plurality of main nozzles included in the combustor are set as the first group, and the plurality of top hat nozzles are set as the second group, and the fuel supply ratio of the first group to the second group is set as the base index. By applying the correction value to the base index, combustion oscillation can be suitably suppressed.

(8) In another aspect, in the aspect of the above (7), the correction value is calculated to decrease the base index.

According to the aspect of the above (8), in a case where the top hat ratio is used as the base index, the base index is corrected to decrease. For example, in a case where the fuel temperature is low, the correction value is calculated such that the amount of decrease in the base index is increased. In this manner, the fuel supply amount by the plurality of main nozzles is increased relative to the fuel supply amount by the top hat nozzle. In this manner, the differential pressure between the plurality of main nozzles is reduced, and the occurrence of combustion oscillation can be suitably suppressed.

(9) A gas turbine control method according to one aspect is a gas turbine control method for controlling a gas turbine (GT) in which a combustor (2) is configured in a form in which a plurality of fuel supply nozzles for supplying fuel are divided into a first group (G1) and a second group (G2), the gas turbine control method including a step of calculating a base index (Pbase) of a control parameter (P) regarding a ratio of a fuel supply amount by the second group to a fuel supply amount by the first group, based on an operating state of the gas turbine, a step of calculating a correction value (Pamd) for correcting the base index, based on the operating state of the gas turbine, and a step of controlling each of the fuel supply amounts by the first group and the second group, based on the control parameter obtained by correcting the base index using the correction value, in which, in the step of calculating the correction value, the correction value is calculated such that an absolute value of the correction value decreases to zero, when a predetermined period (Tmd) elapses from a time when a load is added to the gas turbine after the gas turbine is activated.

According to the aspect of the above (9), the fuel supply control of the gas turbine is performed by using the control parameter related to the ratio of the fuel supply amount by the first group and the second group. In this way, the control parameter is obtained by correcting the base index calculated based on the operating state using the correction value, and thus the operating state of the gas turbine can be shifted from the state where combustion oscillation is likely to occur. Therefore, the control tolerance can be ensured even during the rapid activation in which the fuel temperature is low, and the combustion oscillation can be effectively suppressed. The correction value is calculated such that the absolute value of the correction value decreases to zero when a predetermined period elapses from the time when the load is added to the gas turbine, and thus the control of the gas turbine based on the original base index can be smoothly shifted when the fuel temperature rises and the combustion oscillation risk is reduced. As a result, even in a case where the fuel temperature is low as in the rapid activation, the combustion oscillation can be suitably suppressed.

(10) A gas turbine control program according to one aspect is a gas turbine control program for controlling a gas turbine (GT) in which a combustor (2) is configured in a form in which a plurality of fuel supply nozzles for supplying fuel are divided into a first group (G1) and a second group (G2), the gas turbine control program capable of being executed by using a computer, the gas turbine control program including a step of calculating a base index (Pbase) of a control parameter (P) regarding a ratio of a fuel supply amount by the second group to a fuel supply amount by the first group, based on an operating state of the gas turbine, a step of calculating a correction value (Pamd) for correcting the base index, based on the operating state of the gas turbine, and a step of controlling each of the fuel supply amounts by the first group and the second group, based on the control parameter obtained by correcting the base index using the correction value, in which, in the step of calculating the correction value, the correction value is calculated such that the correction value decreases to zero, when a predetermined period (Tmd) elapses from a time when a load is added to the gas turbine after the gas turbine is activated.

According to the aspect of the above (10), the fuel supply control of the gas turbine is performed by using the control parameter related to the ratio of the fuel supply amount by the first group and the second group. In this way, the control parameter is obtained by correcting the base index calculated based on the operating state using the correction value, and thus the operating state of the gas turbine can be shifted from the state where combustion oscillation is likely to occur. Therefore, the control tolerance can be ensured even during the rapid activation in which the fuel temperature is low, and the combustion oscillation can be effectively suppressed. The correction value is calculated such that the absolute value of the correction value decreases to zero when a predetermined period elapses from the time when the load is added to the gas turbine, and thus the control of the gas turbine based on the original base index can be smoothly shifted when the fuel temperature rises and the combustion oscillation risk is reduced. As a result, even in a case where the fuel temperature is low as in the rapid activation, the combustion oscillation can be suitably suppressed.

### REFERENCE SIGNS LIST

1: compressor
2: combustor
3: turbine
4: rotor
11: inlet
12: compressor casing
13: compressor stator vane
14: compressor rotor blade
21: inner cylinder
22: transition piece
23: outer cylinder
24: combustor casing
26: air passage
31: turbine casing
32: turbine stator vane
33: turbine rotor blade
34: exhaust chamber
34a: exhaust diffuser
41, 42: bearing portion
50: gas turbine control device
51: fuel control unit
52: storage unit
53: pilot fuel supply valve drive unit
54: base index calculation unit
54: A group main fuel supply valve drive unit
55: B group main fuel supply valve drive unit
56: correction value calculation unit
57: top hat fuel supply valve drive unit
60: gain correction unit
62: count unit
64: limiter
251: pilot nozzle
251a: fuel port
251b: pilot fuel line
251c: pilot fuel supply valve
252: main nozzle
252a: fuel port
252b: main fuel line
252c: main fuel supply valve
252d: swirling blade
252e: burner cylinder
253: top hat nozzle
253a: fuel port
253b: top hat fuel line
253c: top hat fuel supply valve
G1: first group
G2: second group
GT: gas turbine
P: control parameter
Pamd: correction value
Pamd′: temporary correction value
Pamd1: first correction value
Pamd2: second correction value
Pamd3: third correction value
Pbase: base index
Ti: temperature-raising required time
TIC: intake air temperature
Tamd: temperature-raising required time correction value
Tf: fuel temperature
Tf0: target fuel temperature
Tgt: gas turbine temperature
Tmd: predetermined period

1. A gas turbine control device for controlling a gas turbine in which a combustor is configured in a form in which a plurality of fuel supply nozzles for supplying fuel are divided into a first group and a second group, the gas turbine control device comprising:
a base index calculation unit for calculating a base index of a control parameter regarding a ratio of a fuel supply amount by the second group to a fuel supply amount by the first group, based on an operating state of the gas turbine;
a correction value calculation unit for calculating a correction value for correcting the base index, based on the operating state of the gas turbine; and
a fuel control unit for controlling each of the fuel supply amounts by the first group and the second group, based on the control parameter obtained by correcting the base index using the correction value,
wherein the correction value calculation unit calculates the correction value such that an absolute value of the correction value decreases to zero, when a predetermined period elapses from a time when a load is added to the gas turbine after the gas turbine is activated.

2. The gas turbine control device according to claim 1,
wherein the predetermined period is set based on a temperature-raising required time of the fuel and on a temperature of the gas turbine at a time of activating the gas turbine.

3. The gas turbine control device according to claim 1,
wherein the correction value is calculated based on an intake air temperature of the gas turbine.

4. The gas turbine control device according to claim 1,
wherein the plurality of fuel supply nozzles include a plurality of main nozzles that are disposed at intervals in a circumferential direction to supply fuel to a plurality of main burners,
the plurality of main nozzles are divided into an A group and a B group, and
the control parameter is KMB, which is a ratio of a fuel supply amount of the main nozzle of the B group selected as the second group to a fuel supply amount of the main nozzle of the A group selected as the first group.

5. The gas turbine control device according to claim 4,
wherein the correction value is calculated to increase the base index.

6. The gas turbine control device according to claim 4,
wherein the numbers of the main nozzles belonging to the first group and the second group are different from each other.

7. The gas turbine control device according to claim 1,
wherein the plurality of fuel supply nozzles include
a plurality of main nozzles that are disposed at intervals in a circumferential direction to supply fuel to a plurality of main burners, and
a plurality of top hat nozzles that supply fuel to fuel introduction paths of the plurality of main burners, and
the control parameter is a ratio of fuel supply amounts of the plurality of top hat nozzles selected as the second group to fuel supply amounts of the plurality of main nozzles selected as the first group.

8. The gas turbine control device according to claim 7,
wherein the correction value is calculated to decrease the base index.

9. A gas turbine control method for controlling a gas turbine in which a combustor is configured in a form in which a plurality of fuel supply nozzles for supplying fuel are divided into a first group and a second group, the gas turbine control method comprising:
a step of calculating a base index of a control parameter regarding a ratio of a fuel supply amount by the second group to a fuel supply amount by the first group, based on an operating state of the gas turbine;
a step of calculating a correction value for correcting the base index, based on the operating state of the gas turbine; and
a step of controlling each of the fuel supply amounts by the first group and the second group, based on the control parameter obtained by correcting the base index using the correction value,
wherein, in the step of calculating the correction value, the correction value is calculated such that an absolute value of the correction value decreases to zero, when a predetermined period elapses from a time when a load is added to the gas turbine after the gas turbine is activated.

10. A gas turbine control program for controlling a gas turbine in which a combustor is configured in a form in which a plurality of fuel supply nozzles for supplying fuel are divided into a first group and a second group, the gas turbine control program capable of being executed by using a computer, the gas turbine control program comprising:
a step of calculating a base index of a control parameter regarding a ratio of a fuel supply amount by the second group to a fuel supply amount by the first group, based on an operating state of the gas turbine;
a step of calculating a correction value for correcting the base index, based on the operating state of the gas turbine; and
a step of controlling each of the fuel supply amounts by the first group and the second group, based on the control parameter obtained by correcting the base index using the correction value,
wherein, in the step of calculating the correction value, the correction value is calculated such that the correction value decreases to zero, when a predetermined period elapses from a time when a load is added to the gas turbine after the gas turbine is activated.
